(19) United States
(12) Patent Application Publication
(10) Pub. No.: US 2001/0028815 A1
(43) Pub. Date: Oct. 11, 2001

(54) Color image forming apparatus

(76) Inventor: Shougo Sato, Seto-shi (JP)

Correspondence Address: OLIFF & BERRIDGE, PLC, 277 S. WASHINGTON STREET, SUITE 500, ALEXANDRIA, VA, 22314, US

(21) Appl. No.: 09/814,798

(22) Filed: Mar. 23, 2001

(30) Foreign Application Priority Data
Mar. 23, 2000 (JP) 2000-087120
Mar. 23, 2001 (JP) 2001-085052

(51) Int. Cl. G03G 15/14

(52) U.S. Cl. 399/223; 430/126; 430/56; 430/108.1; 399/162; 399/298; 399/302

(57) ABSTRACT

A color image forming apparatus includes a photosensitive belt, which consists of a resinous base sheet and an organic photosensitive layer formed thereon. The photosensitive layer consists of a charge transport layer and charge generation particles dispersed therein. The image forming apparatus ensures good color image quality even if the developer used for this former is toner made of styrene-acrylic resin. The image forming apparatus also includes developing rollers in contact with the photosensitive belt. Suitable shearing force can be applied to the toner if the speed ratio of the developing rollers to the photosensitive belt ranges from 1.3 to 2.0. The developer includes an external additive which has a particle diameter of 30 or more nm. The external additive can effectively prevent printed sheets from halation.

### FIELD OF THE INVENTION

The present invention relates to an image forming apparatus for forming an image with an electrified non-magnetic single-component developer. In particular, the invention relates to a color image forming apparatus that performs development with a non-magnetic single-component developer in contact with a photosensitive belt including a photosensitive layer and charge generators dispersed in the layer.

### DESCRIPTION OF THE RELATED ART

A conventionally known image forming apparatus includes a photosensitive drum or another electrostatic latent image carrier, on which an electrostatic latent image can be formed. The image forming apparatus also includes a developing unit for conveying toner or other developer onto the latent image carrier to develop the latent image. The image forming apparatus further includes a supplying unit for supplying developer to the developing unit.

A rotary color image forming apparatus of this type includes four developing units having different color developers. The developing units are supported around a rotating shaft, and can turn around it to come into contact in order with a photoreceptor. Since the switching speed of the developing unit is limited, the rotary color image forming apparatus is not suitable for high-speed operation.

Another known color image forming apparatus includes a movable photosensitive belt as a photoreceptor and a plurality of developing devices containing different color toners. The developing devices are arranged along the photosensitive belt, and can move into contact with it and away from it. The developing devices perform development by coming into contact with the photosensitive belt in order. This increases the switching speed of the developing devices, making it possible to perform high-speed color image formation.

The photosensitive belt includes an electrically conducting sheet, which may be an aluminum vapor-deposited PET film, and a photosensitive layer formed on the conducting sheet. In general, a photosensitive layer is a double layer consisting of a charge generation layer and a charge transport layer. The charge generation layer is formed on a sheet and has a thickness between 2 and 3 microns. The charge transport layer is formed on the charge generation layer and has a thickness of about 20 microns.

However, it takes too much time and trouble to apply the double photosensitive layer to a photosensitive belt, which has a large area. Moreover, the inner charge generation layer is very thin. Consequently, if the conductive base sheet has an even slight surface asperity, it is not possible to form a good charge generation layer on the sheet. This lowers the yield of the product.

There is a structural limitation that, in order to form a positively chargeable double-layer photoreceptor, it is necessary to form a charge generation layer on a charge transport layer. If the charge transport layer were formed on the charge generation layer, it would be necessary to lower the surface potential of the photoreceptor by canceling positive charges on the photoreceptor surface by transporting, through the charge transport layer to this surface, the electrons out of the pairs of holes and electrons generated at exposed portions of the charge generation layer. In general, however, because a charge transport layer transports only holes, the foregoing structure does not make it possible to lower the surface potential. Therefore, in order to lower the surface potential at the exposed portions, it is necessary to form the charge generation layer on the charge transport layer. However, the thin charge generation layer on the outer side of the photoreceptor is damaged by the friction against the developer. This makes the surface potential unstable, resulting in defective printing.

Japanese Patent Application Laid-Open No. 6-258960 discloses an image forming apparatus including a heat-resisting photosensitive film belt and used with toner capsulated in capsules. This image forming apparatus transfers and fixes a toner image at the same time with the film belt. This document discloses a single-layer type photoreceptor as a material for photosensitive film. The photoreceptor includes a photosensitive layer consisting of an electrically conducting substrate, a charge-generating and charge-transporting material on the substrate, and a binder.

Such a single-layer type photoreceptor may be used in a color image forming apparatus which performs development with toner rubbed or contacted on the photoreceptor. In this case, print fog or halation is liable to appear if the combination of a toner and an additive is not sufficiently analyzed and/or examined.

### SUMMARY OF THE INVENTION

In view of the foregoing problems, it is a first object of the present invention to provide a novel color image forming apparatus which includes a single-layer type photosensitive belt, and which can ensure good color image quality by preventing print fog or halation. It is a second object of the invention to provide a novel color image forming apparatus which can maintain good color image quality for a long time.

According to a first aspect of the present invention, there is provided a color image forming apparatus comprising:

a photosensitive belt including a positively chargeable organic photosensitive layer, the photosensitive layer being a single layer including a charge transport layer and charge generators dispersed in the charge transport layer;

a charger facing the photosensitive belt for charging the photosensitive layer;

an exposure device facing the photosensitive belt for exposing the charged photosensitive layer with light to form an electrostatic latent image on the belt;

a plurality of developing devices facing the photosensitive belt each for bringing a non-magnetic single-component developer into contact with the photosensitive belt to stick the developer to the formed latent image to develop a visible color image, the developer including an external additive added thereto, the additive having a particle diameter of 30 or more nm; and

a transfer unit for transferring the visible image onto a transfer medium.

A conventional double-layer positively chargeable photoreceptor includes a charge generation layer as a surface layer. If a developer includes an external additive having a particle diameter of 30 or more nm for improved fluidity, it wears away the surface layer. This makes the surface potential of the photoreceptor unstable, causing defective printing.

The inventor has found out that, if a photosensitive belt including a single-layer organic photosensitive layer is used in a color image forming apparatus of the type for development with a photoreceptor in contact with a developer, it is possible to obtain good image quality for a long time by adding an external additive having a particle diameter of 30 or more nm to a non-magnetic single-component developer. The external additive, which has a particle diameter of 30 or more nm, is not embedded in the toner as the developer, but can be exposed partially in the toner surface. In the process of development, the exposed additive slightly wears away the outer surface of the photoreceptor in frictional contact with it. The charge generators dispersed in the photoreceptor surface deteriorate as time passes. Since the external additive slightly wears away the photoreceptor surface, a new photoreceptor surface is exposed. This maintains the charge-generating function of the organic photosensitive layer for a long time. Since the external additive is not embedded in the toner, the additive can perform its original toner flow-promoting function.

The external additive may have an average particle diameter between 30 nm and 1 micron. It is preferable that the average diameter range between 30 and 100 nm. The external additive may be one selected from a group consisting of silica, alumina and titanium oxide.

The developer may be a toner including a binder made of positively chargeable styrene-acrylic resin, which is a styrene-acrylic copolymer. The developer may further include a charge control agent made of styrene-acrylic resin.

The charger may be a scorotron type charger, which can very uniformly charge the photosensitive belt. In cooperation with the positively chargeable organic photosensitive layer, the scorotron type charger can reduce the generation of ozone in quantity. Therefore, this charger is good environmentally as well.

The photosensitive belt may further include a resinous belt and an electrically conducting layer formed on the resinous belt. The organic photosensitive layer lies on the conducting layer. Both ends of the belt may be joined together so that it may be endless. The conducting layer can be used as a grounding layer. In this case, the sheet can be made of inexpensive material in comparison with a case where the sheet itself is electrically conductive and used as a grounding layer.

The organic photosensitive layer may have a thickness of 18 or more microns. In this case, the photosensitive layer absorbs light, so that uneven exposure due to light interference fringes is not striking.

According to a second aspect of the present invention, there is provided a color image forming apparatus comprising:

a photosensitive belt including a positively chargeable organic photosensitive layer, the photosensitive layer being a single layer including a charge transport layer and charge generators dispersed in the charge transport layer;

a charger facing the photosensitive belt for charging the photosensitive layer;

an exposure device facing the photosensitive belt for exposing the charged photosensitive layer to light to form an electrostatic latent image on the belt;

a plurality of developing devices facing the photosensitive belt each for bringing a developer into contact with the photosensitive belt to stick the developer to the formed latent image to develop a visible color image, the developer being a non-magnetic single-component developer made of styrene-acrylic resin; and

a transfer unit for transferring the visible image onto a transfer medium.

The inventor has succeeded in preventing print fog or halation effectively by using a photosensitive belt including a single-layer organic photosensitive layer in a color image forming apparatus of the type for development with a photoreceptor in contact with a positively chargeable developer, which may particularly be a toner made of styrene-acrylic resin.

In a conventional image forming apparatus including a drum type single-layer photoreceptor with dispersed charge generators, print fog may occur if a positively chargeable developer is used which is a toner made of styrene-acrylic resin. According to the inventor's research, this has been found to be based on a phenomenon that will be explained below with reference to FIGS. 4A and 4B of the accompanying drawings.

FIG. 4A shows a developing roller 52 and a photoreceptor 300, which has an outer surface 300a. As shown in FIG. 4B, a developing bias potential V_{B} is applied in advance to the developing roller 52. The photoreceptor surface 300a is charged at V₀ in advance by a charger (not shown). Part of the photoreceptor surface 300a is exposed to light by an exposure device (not shown). The exposed part is discharged, and its potential is lowered to V_{L}.

In the developing process, the developing roller 52 with toner 40 adhering to its cylindrical surface comes into contact with the photoreceptor surface 300a with an electrostatic latent image formed on it. The photoreceptor 300 and the developing roller 52 carrying toner 40 move at different speeds. Consequently, when the toner 40 comes into contact with the photoreceptor 300, charges move between the toner 40 and the surface layer of the photoreceptor 300. This is conceived to be a problem peculiar to single-layer photoreceptors including charge generators dispersed in their surface layers. The charge movement decreases the potential of the photoreceptor surface 300a from V₀ to V₀′.

Because the toner 40 is positively charged in advance, the toner on the cylindrical surface of the developing roller 52 increases the potential of this surface by the charge potential of the toner.

The toner 40 may be a positively chargeable toner made of styrene-acrylic resin. When the positively chargeable toner 40 comes into contact with the photoreceptor 300, frictional electrification increases the amount of charge on the toner. This further increases the surface potential of the developing roller 52 by the increased amount of charge on the toner. If the toner charge increases the surface potential of the developing roller 52 by a value of ΔV, the effective developing bias potential is V_{B}+ΔV. As a result, as shown in FIG. 4B, the decreased charge potential V₀′, of the photoreceptor surface 300a approaches the effective developing bias potential V_{B}+ΔV. Consequently, part of the toner 40 may stick to the non-exposed part of the photoreceptor surface 300a. This develops the photoreceptor part where no electrostatic latent image is formed. As a result, print fog occurs. In particular, with respect to the conventional drum type photoreceptor, it is conceivable that, because toner is rubbed on the drum with strong force, the charge potential drops and the developing bias potential rises.

In the present invention, because a photoreceptor in the form of a belt is used as a single-layer photoreceptor, a small pressure or a small shearing force is applied on toner, in comparison with the drum type photoreceptor. It is possible to prevent print fog by effectively adjusting this pressure or shearing force by adjusting the bias pressure on the belt. The bias pressure may be 9.8 N (1,000 gf) or lower and should preferably be 1.96 N (200 gf) or lower, and more preferably be 0.98 N (100 gf) or lower. It is also possible to apply a good shearing force to the toner by making the peripheral speed ratio of the developing rollers to the photosensitive belt range from 1.3 to 2.0. If this speed ratio is less than 1.3, the developing rollers may supply an insufficient amount of developer to the photoreceptor. If the speed ratio is more than 2.0, the shearing force is so great that print fog is liable to occur, and the photoreceptor is worn away remarkably. Each developing roller may be urged against the belt with springs connected to both ends of the roller. This is the simplest and securest urging method. The urged or bias pressure applied by one of the springs is a half of each of the foregoing values.

The developer of the present invention may include a charge control agent made of styrene-acrylic resin. Even if such a charge control agent is included, print fog can be prevented effectively.

### BRIEF DESCRIPTION OF THE DRAWINGS

A preferred embodiment of the present invention will be described below in detail with reference to the accompanying drawings, in which:

FIG. 1 is a schematic side view in cross section of a laser beam printer embodying the invention;

FIG. 2 is a cross section of a photosensitive belt for use in the printer shown in FIG. 1;

FIG. 3 is a cross section of another photosensitive belt for use in the printer shown in FIG. 1;

FIG. 4A is a conceptual view showing how the toner supplied by a developing roller comes into contact with a photoreceptor in a developing process;

FIG. 4B is a chart showing the potentials at different points in FIG. 4A.

### DETAILED DESCRIPTION OF THE PREFERRED EMBODIMENT

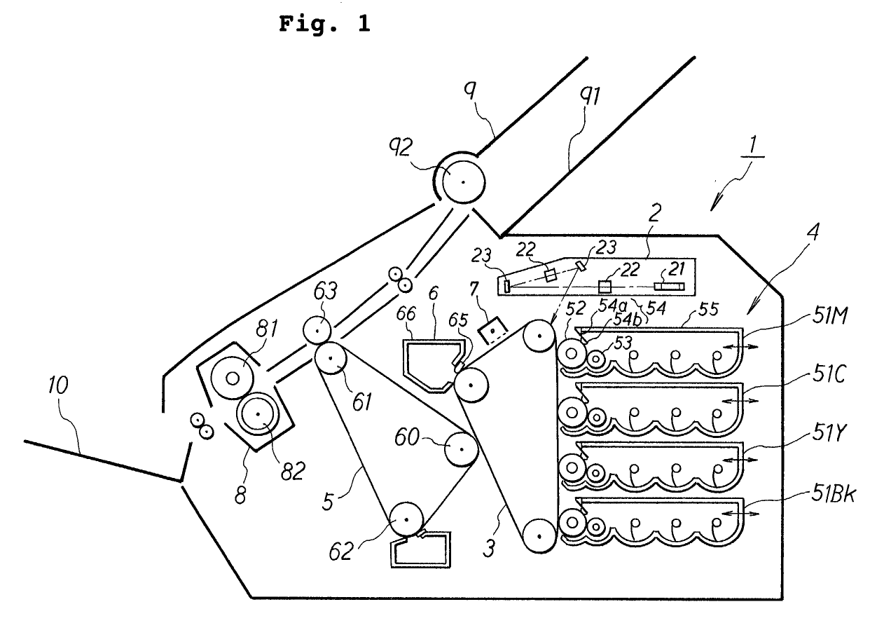

With reference to FIG. 1, a color laser printer 1 as a color image forming apparatus includes a scanning unit 2 as an exposure unit, a photosensitive belt 3, a developing unit 4 including four developing devices, an intermediate transfer belt 5, a cleaner 6, a charger 7, a fixing unit 8, a paper feed unit 9 and a paper discharge tray 10.

The scanning unit 2 includes a laser light source (not shown), a polygonal mirror 21, a lens 22 and mirrors 23, and irradiates the outer side of the photosensitive belt 3 with laser beams based on image data.

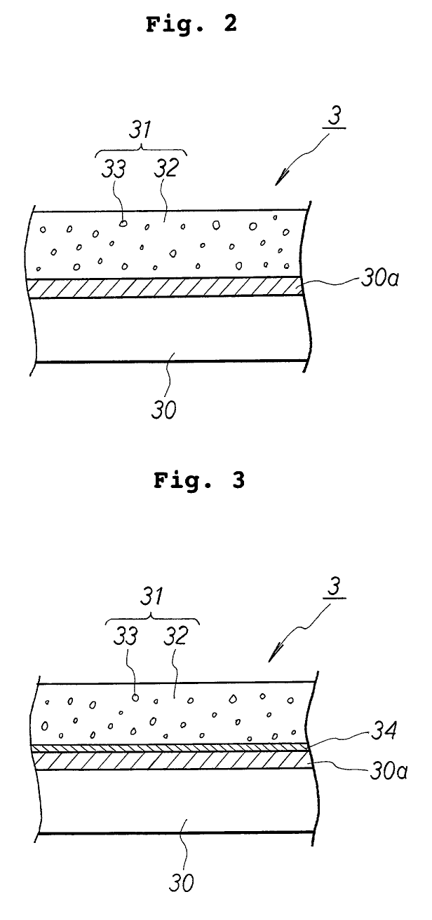

As shown in FIG. 2, the photosensitive belt 3 may, as an example, consist of a base sheet 30 and a photosensitive layer 31. The base sheet 30 may be a PET film with an aluminum vapor-deposited film 30a formed as a conducting layer on one side. The photosensitive layer 31 is a single layer for positive electrification or charging, which is formed on the aluminum film 30a. The photosensitive layer 31 is a charge transport layer 32 with charge generation particles 33 dispersed in it.

The charge transport layer 32 may be a hydrazone derivative, a pyrazoline derivative, an oxandiazole derivative, an arylamine derivative or a styryl derivative, and should preferably be an arylamine derivative.

The charge generation particles 33 may be a perylene pigment, a polycyclic quinone pigment, an antho-anthrone pigment, a tris-azo pigment, a phthalocyanine pigment, a bis-azo pigment or a squalium pigment, and should preferably be a perylene pigment or a phthalocyanine pigment.

The photosensitive layer 31 has a thickness of 18 or more microns. The conducting layer 30a is used as a grounding layer.

As stated above, the photosensitive belt 3 may consist of a base sheet 30 and a photosensitive layer 31, which lie on each other to form a sheet. Both ends of this sheet are joined together so that it is endless. Alternatively, the photosensitive belt 3 may include a base sheet 30, both ends of which are joined together so that it is endless. A photosensitive layer 31 is formed on the endless base sheet 30.

The developing unit 4 includes a magenta developing device 51M, a cyan developing device 51C, a yellow developing device 51Y and a black developing device 51B, which contain magenta, cyan, yellow and black toners, respectively. The developing devices 51M, 51C, 51Y and 51B are arranged along the photosensitive belt 3, and can reciprocate in the directions indicated with arrows in FIG. 1. Each of the developing devices 51M, 51C, 51Y and 51B is in contact with the photosensitive belt 3 during development for the associated color, and moves away from the belt when the development ends.

Each of the developing devices 51M, 51C, 51Y and 51B includes a cylindrical developing roller 52. The developing roller 52 is made basically of electrically conducting silicone rubber and coated with a layer of rubber or resin which contains fluorine. Alternatively, the developing roller 52 might be made basically of electrically conducting urethane rubber in place of conducting silicone rubber. The average roughness (Rz) at ten points on the developing roller 52 is 5 or less microns. This average roughness is smaller than the average particle diameter of the toners, which is 9 microns. A voltage, which may be 400 volts, is applied to the developing roller 52 so that there is a potential difference between it and the photosensitive belt 3.

Each of the developing devices 51M, 51C, 51Y and 51B also includes a supply roller 53. The supply roller 53 is an electrically conducting sponge roller, which is kept in compressive contact with the associated developing roller 52 by the elastic force of sponge. Alternatively, the supply roller 53 might be made of electrically conducting silicone rubber or urethane rubber.

Each of the developing devices 51M, 51C, 51Y and 51B further includes a case 55 and a layer thickness control blade 54. The control blade 54 includes a support portion 54a, which may be made of stainless steel, and one end of which is fixed to the case 55. The control blade 54 also includes a contact portion 54b supported by the other end of the support portion 54a. The contact portion 54b may be made of electrically conducting silicone rubber, electrically conducting rubber which contains fluorine, or electrically conducting resin. The elastic force of the support portion 54a keeps the contact portion 54b in compressive contact with the associated developing roller 52. As shown in FIG. 1, the contact portion 54b is roughly semilunar in cross section. A voltage is applied to the control blade 54.

The toner contained in the case 55 of each developing device is a positively chargeable non-magnetic single-component developer. This toner includes base particles having an average diameter of 9 microns. Each base particle includes a styrene-acrylic resin formed into balls by suspension polymerization. Added to the balls are a carbon black or another known colorant, a charge control agent such as nigrosine, triphenylmethane, a quaternary ammonium salt, or a charge control resin such as styrene-acrylic resin having a quaternary ammonium base. Silica is added as an external additive to the surfaces of the base particles. The external additive has undergone a known hydrophobing process with a silane coupling agent, a silicone oil or the like, and has an average particle diameter of 10 nm. The amount of added silica is 0.6 weight % of the base particles.

Thus, the toners are nearly spherical particles formed by suspension polymerization. Moreover, 0.6 weight % silica having an average particle diameter of 10 nm and hydrophobed is added as an external additive to the toners. This makes the toners very fluid, so that they can be charged sufficiently by frictional electrification. The toner particles are not pulverized, or ground, and are therefore round. The round particles are not subject to mechanical force, well follow an electric field and are high in transfer efficiency.

An electrostatic latent image can be formed as positive charges on the photosensitive belt 3. The latent image formed on the photosensitive belt 3 can be developed well by the reversal development method with the positively charged toners on the developing rollers 52. This makes it possible to form a very high-quality image.

Particles of suspension-polymerized toner are known for low mechanical strength. An external additive having an average particle diameter of 30 or less nm sufficiently improves the flow, or fluidity, of a non-magnetic single-component developer, making it possible to form a very high-quality image, but is known for its liability to be embedded in base particles of toner when pressed. Consequently, if layer thickness control blades made of metal are used as is the case with a conventional image forming apparatus, not only may the external additive be embedded in the base particles of the toner, but the toner may weld to the control blades.

Therefore, in this embodiment, an external additive (flow promoter) having an average particle diameter of 30 or more nm is added to the toners. The external additive may not only be silica but also be alumina or titanium oxide. The average particle diameter may range from 30 nm to 1 micron and should preferably range from 30 to 100 nm.

The intermediate transfer belt 5 is formed out of an electrically conducting sheet of polycarbonate, polyimide or the like. As shown in FIG. 1, the transfer belt 5 extends around three rollers 60, 61 and 62. The roller 60 is supported in contact with the photosensitive belt 3. A voltage is applied to this roller 60 so that the toner image formed on the photosensitive belt 3 can be transferred onto the transfer belt 5. The roller 61 is supported in the position where the toner image can be transferred onto a sheet of paper. The transfer belt 5 runs under compression between this roller 61 and a roller 63. A voltage is applied to this roller 63 so that the four-color toner image on the transfer belt 5 can be transferred onto the sheet of paper.

The cleaner 6 consists of a scraper 65 and a case 66. The scraper 65 scrapes off the toners remaining on the photosensitive belt 3. The scraped toner is retained in the case 66.

The charger 7 is a scorotron type charger, which uniformly electrifies the photosensitive layer 31 of the photosensitive belt 3.

The fixing unit 8 includes a heating roller 82 and a pressing roller 81. When the sheet of paper carrying the toner image passes between these rollers 81 and 82, the sheet is heated and pressed so that the image can be fixed onto it.

The feed unit 9 includes a feed tray 91, which is stacked with sheets of paper, and a pickup roller 92 for feeding the sheets of paper one after one. The feed unit 9 feeds sheets of paper toward the rollers 61 and 63 in a timed fashion with respect to the image forming process performed by the scanning unit 2, the developing unit 4, the photosensitive belt 3 and the transfer belt 5.

The discharge tray 10 is supported on the discharging side of the fixing unit 8, and retains the sheets of paper discharged from the fixing unit.

The operation of this color laser printer will be explained.

The charger 7 uniformly charges the photosensitive layer 31 of the photosensitive belt 3. The charged layer 31 is then exposed to laser beams based on a magenta image and radiated by the scanning unit 2. The magenta developing device 51M then moves into contact with the photosensitive belt 3, and sticks magenta toner to the electrostatic latent image formed on the exposed layer 31. This effects magenta development, forming a magenta toner image on the photosensitive belt 3. The toner image is once transferred onto the intermediate transfer belt 5.

The cleaner 6 removes the toner remaining on the photosensitive belt 3 after the image transfer. After the toner removal, the charger 7 charges the photosensitive layer 31 of the photosensitive belt 3 uniformly again. Next, the charged layer 31 is exposed to laser beams based on a cyan image and radiated by the scanning unit 2. Cyan development similar to the magenta development is then effected for the exposed layer 31, forming a cyan toner image on the photosensitive belt 3.

The cyan toner image is then transferred onto the intermediate transfer belt 5 in such a manner that this image is superposed on the magenta toner image borne on the transfer belt 5. The transferred cyan image is borne on the transfer belt 5.

Subsequently, similar processes are performed for the other two colors. As a result, a four-color toner image is formed on the intermediate transfer belt 5. This toner image is then transferred onto a sheet of paper passing between the transfer belt 5 and the roller 63 in compressive contact with this belt. The transferred toner image is then fixed onto the sheet passing through the fixing unit 8, from which the sheet is then discharged onto the discharge tray 10.

Because the photosensitive belt 3 provides a longer surface for contact with the developing devices 51M, 51C, 51Y and 51B, they can be arranged vertically as shown in FIG. 1. The developing devices 51M, 51C, 51Y and 51B might alternatively be arranged horizontally. Accordingly, in comparison with the rotary type color image forming apparatus, it is possible to switch the developing devices 51M, 51C, 51Y and 51B at a high speed, making it possible to increase the print speed.

Because the organic photosensitive layer 31 of the photosensitive belt 3 is positively chargeable, the use of the scorotron type charger 7 generates only a very small amount of ozone. The scorotron type charger 7 can very uniformly charge the photosensitive layer 31.

Because the photosensitive belt 3 includes a dispersion type single organic photosensitive layer 31 consisting of a charge transport layer 32 and charge generation particles 33 dispersed in this layer 32, it is not necessary to form a thin charge generation layer on an electrically conducting base sheet 30, as is the case with the conventional art. This makes it possible to form a good photosensitive layer on a belt, which has a large area, without lowering the producing yield.

Even if the dispersion type single organic photosensitive layer 31 is worn away, as is the case with the conventional double photosensitive layer, the surface potential is stable, so that no defective printing occurs. In particular, if an external additive having a particle diameter of 30 or more nm is added to a non-magnetic single-component developer, as stated earlier on, the surface layer of the photosensitive layer 31 is worn away little by little. However, the characteristics of the single organic photosensitive layer 31 do not change. Contrariwise, because the charge-generating function of the surface of the photosensitive layer 31 worsens as time passes, it is possible to expose a new surface of this layer by wearing away the surface layer slightly with the external additive. As is the case with the surface which has not yet worn away, charge generation particles are dispersed in the new surface. Because the external additive added to the developer is 30 or more nm in particle diameter, the additive is prevented from being embedded in the base particles of the toners, even though the developer is a non-magnetic single-component developer. This prevents the toner fluidity from lowering.

In particular, a system including an intermediate transfer belt 5 involves two transfer steps for one toner. One of the steps is the transfer from a photosensitive belt 3 to the transfer belt 5, and the other is the transfer from the transfer belt 5 to a sheet of paper. Accordingly, if the toner fluidity lowers, the image quality worsens remarkably. In the embodiment, as stated above, the external additive added to the developer is 30 or more nm in particle diameter so as not to be embedded in the base particles of the toners. This securely prevents the toner fluidity from lowering. As a result, the color printer according to the embodiment ensures good image quality.

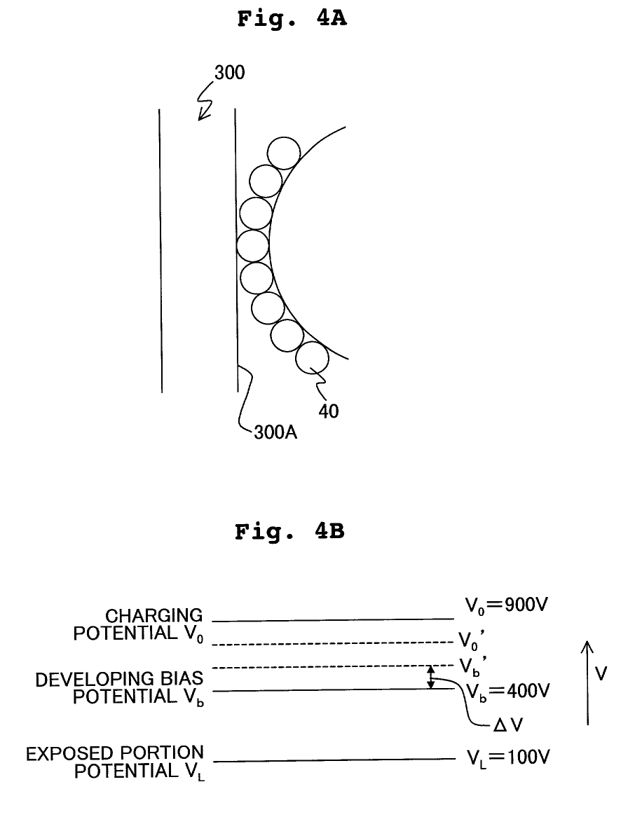

In particular, this color printer performs development with a non-magnetic single-component developer by pressing the developing rollers 52 against the photosensitive belt 3. Because relatively small shearing force is applied to the developer, print fog is prevented from appearing. This is effective particularly if the developer is a styrene-acrylic resin or another positively chargeable developer. In particular, it is possible to adjust the shearing force by suitably adjusting the difference between the speed of the developing rollers 52 and that of the photosensitive belt 3. According to the inventor's experiment, it is preferable that the peripheral speed ratio of the developing rollers 52 to the photosensitive belt 3 should range from 1.3 to 2.0. If this speed ratio is less than 1.3, the developing rollers 52 supply an insufficient amount of developer. If the speed ratio is more than 2.0, as explained in connection with FIG. 4B, the frictional electrification of the developer and photoreceptor is great. This lowers the charge potential and raises the developing bias potential. As a result, print fog is liable to appear. It is possible to apply suitable shearing force to the developer by suitably adjusting the bias pressure that the photosensitive belt 3 applies on the developing rollers 52 or the developer adhering to each developing roller. The bias pressure may be 9.8 N (1,000 gf) or lower and should preferably be 1.96 N (200 gf) or lower, and more preferably be 0.98 N (100 gf) or lower.

The photosensitive belt 3 is resinous and includes an electrically conducting layer 30a as a grounding layer, which is an aluminum vapor-deposited film. The photosensitive belt 3 also includes an organic photosensitive layer 31 lying on the conducting layer 30a. This structure of the photosensitive belt 3 makes it possible to use an inexpensive material for the sheet in comparison with an electrically conducting sheet used as a grounding layer. The use of an inexpensive material for the sheet makes the surface of the grounding layer less smooth. However, because the photosensitive layer 31 is a single organic layer, as stated earlier on, this layer is not difficult to form.

The photosensitive belt 3 is formed as an endless belt with both ends joined together, and can therefore be produced more easily and cheaply than a photosensitive belt formed originally as a seamless belt. The surface of the joint of the photosensitive belt 3 is less precise. However, the lower precision of the surface does not adversely affect the decrease in surface potential because the photosensitive belt 3 includes a single-layer type organic photoreceptor. Alternatively, the photosensitive belt 3 might have such a structure that images can be formed on its portion other than the joint.

The photosensitive belt 3 is in direct contact with the intermediate transfer belt 5. As stated earlier on, the single organic photosensitive layer 31 lies on the conducting layer 30a as the grounding layer of the photosensitive belt 3, and prevents the grounding layer from being exposed. Consequently, no excess current flows from the transfer belt 5 to the grounding layer 30a.

The single organic photosensitive layer 31 is 18 or more microns in thickness and can therefore be produced stably.

Charge generation concentrates near the surface of a single photosensitive layer in contrast to a double photosensitive layer. Consequently, if the single layer has an unevenness in thickness that is nearly equal to half the wave length of the laser beams to which this layer is exposed, uneven exposure may be caused by the interference of the beams with the light reflected by the conducting sheet of a substrate.

However, because the single organic photosensitive layer 31 is 18 or more microns in thickness, the dispersed charge generation particles 33 absorb light. This decreases the reflected light sufficiently in quantity by the time when the light reaches the vicinity of the surface of the photosensitive layer 31. This restrains the interference from occurring in the photosensitive layer 31. It is therefore possible to prevent uneven exposure due to interference fringes.

The organic photosensitive layer 31 is a single layer consisting of a charge transport layer 32 and charge generation particles 33 dispersed in it. As shown in FIG. 3, the photosensitive belt 3 may further include a protective layer 34, which may be an alumite layer, formed on the conducting layer 30a as the grounding layer. In this case, for example, even if a somewhat high voltage is applied to the roller 60, which is supported in the position where the photosensitive belt 3 is in contact with the transfer belt 5, no potential damages the organic photosensitive layer 31.

The color image forming apparatus according to the present invention includes a photosensitive belt, which includes a single organic photosensitive layer. The photosensitive belt is used with a non-magnetic single-component developer, to which an external additive having a particle diameter of 30 or more nm is added. This ensures good image quality for a long time. The developer may be a non-magnetic single-component positively chargeable developer, which should particularly be a styrene-acrylic resin. This ensures good image quality by preventing print fog from appearing. In particular, it is possible to prevent print fog more securely by adjusting the ratio of the peripheral speed of the developing rollers to that of the photosensitive belt or the bias pressure applied on the rollers by the belt.

The present invention may likewise be applied to a copying machine or another image forming apparatus that forms an electrostatic latent image by using laser beams reflected by a subject copy. The invention may also be applied to an image forming apparatus for use with a non-magnetic single-component developer other than a suspension-polymerized toner, for example, an image forming apparatus for use with an emulsion-polymerized toner or another polymerized toner, or a pulverized toner. The developers may be made of various materials, and the image forming apparatus may consist of various parts. The materials and parts may be those disclosed in U.S. Pat. No. 5,783,347, the disclosure in which is incorporated herein by reference.

What is claimed is:

1. A color image forming apparatus comprising:
a photosensitive belt having a positively chargeable organic photosensitive layer, the photosensitive layer being a single layer including a charge transport layer and charge generators dispersed therein;
a charger facing the photosensitive belt for charging the photosensitive layer;
an exposure unit facing the photosensitive belt for exposing the charged photosensitive layer with light to form an electrostatic latent image on the belt;
a plurality of developing devices facing the photosensitive belt each for bringing a non-magnetic single-component developer into contact with the photosensitive belt to stick the developer to the formed latent image to develop a visible color image, the developer including an external additive added thereto, which has a particle diameter of 30 or more nm; and
a transfer unit for transferring the visible image onto a transfer medium.

2. The color image forming apparatus according to claim 1, wherein the external additive has an average particle diameter between 30 and 100 nm.

3. The color image forming apparatus according to claim 2, wherein the external additive is one selected from a group consisting of silica, alumina and titanium oxide.

4. The color image forming apparatus according to claim 1, wherein the developer is a toner made of styrene-acrylic resin.

5. The color image forming apparatus according to claim 4, wherein the developer includes a charge control agent made of styrene-acrylic resin.

6. The color image forming apparatus according to claim 1, wherein the charger is a scorotron type charger.

7. The color image forming apparatus according to claim 1, wherein the photosensitive belt further includes:
a resinous belt with both ends joined together so that the belt is endless; and
an electrically conducting layer formed on the resinous belt, the photosensitive layer lying on the conducting layer.

8. The color image forming apparatus according to claim 1, wherein the photosensitive layer has a thickness of 18 or more microns.

9. A color image forming apparatus comprising:
a photosensitive belt having a positively chargeable organic photosensitive layer, the photosensitive layer being a single layer including a charge transport layer and charge generators dispersed in the charge transport layer;
a charger facing the photosensitive belt for charging the photosensitive layer;
an exposure unit facing the photosensitive belt for exposing the charged photosensitive layer with light to form an electrostatic latent image on the belt;
a plurality of developing devices facing the photosensitive belt each for bringing a developer into contact with the photosensitive belt to stick the developer to the formed latent image to develop a visible color image, the developer being a non-magnetic single-component developer made of styrene-acrylic resin; and
a transfer unit for transferring the visible image onto a transfer medium.

10. The color image forming apparatus according to claim 9, wherein the developing devices each include a developing roller for supplying the developer to the photosensitive belt;
the image forming apparatus having a peripheral speed ratio of the developing roller to the photosensitive belt, the speed ratio ranging from 1.3 to 2.0.

11. The color image forming apparatus according to claim 9, wherein the developer includes a charge control agent made of styrene-acrylic resin.

12. The color image forming apparatus according to claim 9, wherein the charger is a scorotron type charger.

13. The color image forming apparatus according to claim 9, wherein the photosensitive belt further includes:
a resinous belt with both ends joined together so that the belt is endless; and
an electrically conducting layer formed on the resinous belt;
the photosensitive layer lying on the conducting layer.

14. The color image forming apparatus according to claim 9, wherein the photosensitive layer has a thickness of 18 or more microns.
